(19) United States
(12) Patent Application Publication
(10) Pub. No.: US 2007/0143181 A1
(43) Pub. Date: Jun. 21, 2007

(54) Fully automated interactive promotion tool including wizard-driven web interface

(76) Inventors: Josh Linkner, Bloomfield Hills, MI (US); Robb Lippitt, Bloomfield Hills, MI (US)

Correspondence Address: REED SMITH LLP, P.O. BOX 488, PITTSBURGH, PA, 15230-0488, US

(21) Appl. No.: 11/488,462

(22) Filed: Jul. 18, 2006

Related U.S. Application Data
(60) Provisional application No. 60/750,875, filed on Dec. 16, 2005.

(51) Int. Cl. G06Q 30/00

(52) U.S. Cl. 705/14

(57) ABSTRACT

Systems and methods for providing web-based promotions and promotional tools. The system allows smaller marketers to quickly and easily build and deploy a customized and professional web-based promotion using a fully automated interactive promotional tool including a wizard-driven web interface. The promotion wizard guides an advertiser through the process of designing all aspects of an online promotion including the selection of one or more prize pools and types of promotions, as well as uploading logos and selecting other aesthetic aspects of the promotion. The promotion is preferably distributed using unique distribution channels, and the advertiser is provided with a variety of administrative and management functions by the system in order to manage certain aspects of the online promotion.

### CROSS-REFERENCE TO RELATED APPLICATION

This application claims the benefit under 35 U.S.C. §119(e) of the earlier filing date of U.S. Provisional Application Ser. No. 60/750,875 filed on Dec. 16, 2005.

### BACKGROUND OF THE INVENTION

1. Field of the Invention

The present invention relates generally to systems and methods for providing web-based promotions and promotional tools, and, more specifically, the present invention allows smaller marketers to quickly and easily build and deploy a customized and professional web-based promotion using a fully automated interactive promotional tool including a wizard-driven web interface.

2. Description of the Background

Sweepstakes, instant-win games, and other interactive promotions are the number one most effective tool to convert anonymous users into known, permission-based relationships. According to Forrester Research, 82% of consumers are willing to provide personal data in exchange for the chance to win. These tools have consistently been useful in traditional print media and are quickly proving extremely effective in the online world.

Put simply, research shows that promotions work. For example, 7 in 10 consumers indicate that they are influenced by promotions, and only 19% of consumers have never purchased a product or service due to a promotion (a statistic that has been consistent over the past 15 years). Moreover, promotions have been shown to motivate purchasing across age, gender and income lines because of a strong belief that “someone has to win and it could be me.” In the realm of promotion, a sweepstakes offer combined with a guarantee of no misuse of consumer data (which is often even a bigger concern in online promotion) is by far the most effective motivator to attract registration data which can then be used for additional targeted marketing.

Generally speaking, cost-per-click advertising in the online world is at an all-time high. However, this is only half of the relevant equation. While getting a consumer to a website is an important first step of this process, motivating a registration is the next critical step in the marketing process. Therefore, the registration data and opt-in permission become the cornerstone of a direct-marketing relationship.

Historically there have been many obstacles and barriers to deploying interactive promotions quickly and with low risk to the offering company. For example, complex computing and data mining technology is required to accomplish the tasks of hosting, security, data-capture and reporting. Moreover, the most effective promotions often include aspects that are difficult and expensive to build and implement (such as instant-win, trivia, tell-a-friend and the like). Legal hurdles, that often vary widely from jurisdiction to jurisdiction, add time, expense, risk and complexity beyond the reach of most small businesses. Finally, the prize/reward costs have traditionally been fixed in advance and are very high, thereby making the launch of a promotion a significant investment with no guarantee of results. Obviously, the bigger the prizes offered, the more likely customers are to register and provide relevant information.

In sum, interactive promotion marketing is highly effective, but complex and historically expensive. Learning the best practices and launching a successful campaign is no easy proposition and is well beyond the knowledge and resources of all but the largest online businesses. In the same way, third party experts in promotions often charge large sums of money to setup and administer promotions because each promotion must be specifically targeted to a distinct segment of customers.

There is a need in the art, therefore, to lessen the burden of creating and administrating large online promotions while providing a high level of customization and professional appeal to the promotion. The present invention, in its several preferred embodiments, uses a combination of electronic creation tools, unique distribution channels and promotional hosting tools to provide access to highly interactive and complex web-based promotional tools to all businesses. Through the unique combination of tools described herein, significant technological and financial barriers of the past and present have been broken.

### SUMMARY OF THE INVENTION

In accordance with at least one preferred embodiment, the present invention provides systems and methods for providing interactive web-based promotion tools to businesses. At its core, the present invention interweaves three distinct technologies:

(1) an automated, wizard-driven promotion builder which allows companies to customize and tailor an online promotion without the need for a large amount of specialized knowledge and technical skill;

(2) drawings and prizes which are pooled among a variety of different businesses in order to share the cost of the promotion, speed the time to market, and generally simplify the process for all involved; and

(3) automated distribution of the promotion (once built) to consumers via known distribution channels (such as search engines) in a way that provides free deployment of the promotion and charges only a fee per actual registration by consumers or other cost-per-action fee.

The combination of these three core concepts provides a fully-automated interactive promotion tool that allows advertisers (especially small companies) to build and deploy a professional-looking promotion using a wizard-driven web-based interface. Within a short time frame (preferably as little as 5-10 minutes), the advertiser has a complete promotion based upon all of the applicable expertise (e.g., technological, legal, prizing, etc.), which is valid in all 50 states or other designated jurisdiction, without possessing the requisite expertise itself.

Advertisers will be allowed to launch these promotions with little or no upfront cost, paying only a cost-per-registration fee billed to their credit card. As a bolt-on to existing web-based services (e.g., search engines, small business networks and the like), the present invention will significantly increase conversion rates and thereby increase the value of existing advertising. In short, the present invention puts the proven techniques of large-brand advertisers in the hands of millions of small businesses with little or no upfront cost, knowledge or technical skills.

More specifically, the methods and systems of the present invention utilize an interactive web-based promotion wizard that guides the advertiser through the detailed process of creating an online promotion. The wizard matches the advertiser to one or more applicable prize pools (which are shared among a variety of different businesses) and provides graphical choices from which the advertiser can choose promotion features. These promotion features include the type of promotion, the theme and color scheme of the promotion and/or the types of customer (i.e., end user or promotion registrant) information that is collected by the system and reported to the advertiser.

In addition to providing the guidance and requisite technical/legal expertise, the system also preferably enables the advertiser to customize its online promotion to maximize the potential for customer registration based on unique aspects of the advertiser's industry or specific business. For example, advertisers can upload company logos to the promotion and define promotion add-on features such as electronic/paper coupons, email direct sales to customers and tell-a-friend referral programs. These and other customizable features of the promotion builder system avoid the “cookie cutter” approach that small business currently employ in promotional marketing due to cost concerns.

Finally, the present invention utilizes a unique cost approach to online promotions. Since the promotion is created using the automated promotion wizard, the promotion can be developed and rolled out to the advertiser (and customers at large) without any upfront cost. Instead, advertisers are charged a per-registration, per-customer, or per-game-play cost that accurately reflects the success or failure of the promotion. The system preferably includes a budgeting feature with which an advertiser pre-approves only a discreet amount of money to spend on the promotion based on customer use, and the system automatically monitors this budget and informs the advertiser when it approaches its budgeted amount (or deactivates the promotion if the budget is met or exceeded).

### BRIEF DESCRIPTION OF THE DRAWINGS

For the present invention to be clearly understood and readily practiced, the present invention will be described in conjunction with the following figures, wherein like reference characters designate the same or similar elements, which figures are incorporated into and constitute a part of the specification, wherein:

FIG. 1 is a flow chart showing a high level overview of the user process for creating an online promotion;

FIG. 2 details exemplary steps in the beginning stages of an advertiser's use of the promotion builder;

FIG. 3 is a continuation of the promotion builder process shown in FIG. 2;

FIG. 4 details some of the promotion management tools that can be utilized by the advertiser to manage various aspects of their online promotion;

FIG. 5 shows a flow chart of the pooled drawing aspects of the present invention;

FIG. 6 is a screen capture of the promotion builder wizard showing various categories of prizes;

FIG. 7 is a screen capture of the promotion builder wizard after a “Home & Garden” themed instant win prize is selected;

FIG. 8 is a screen capture of the promotion builder wizard showing three types of instant win games;

FIG. 9 is a screen capture of the promotion builder wizard showing a demo of a Scratch-n-Win game;

FIG. 10 is a screen capture of the promotion builder wizard after the Scratch-n-Win game has been added to the advertiser's promotion;

FIG. 11 is a screen capture of the promotion builder wizard showing exemplary personalization options;

FIG. 12 is a screen capture of the promotion builder wizard in which four distinct add-ons are offered to the advertiser;

FIG. 13 is a screen capture of the promotion builder wizard detailing the coupon builder process;

FIG. 14 is a screen capture of the promotion builder wizard with an updated customized promotion based on advertiser selections; and

FIG. 15 is a screen capture of the promotion builder wizard detailing certain customer registration options.

### DETAILED DESCRIPTION OF THE INVENTION

It is to be understood that the figures and descriptions of the present invention have been simplified to illustrate elements that are relevant for a clear understanding of the invention, while eliminating, for purposes of clarity, other elements that may be well known. Those of ordinary skill in the art will recognize that other elements are desirable and/or required in order to implement the present invention. However, because such elements are well known in the art, and because they do not facilitate a better understanding of the present invention, a discussion of such elements is not provided herein. The detailed description will be provided herein below with reference to the attached drawings.

The present invention, in at least one preferred embodiment, provides interactive, wizard-based tools for use by advertisers to create customized and professional-looking online promotions without going through the time and expense of learning all of the relevant aspects of the technology, marketing and legal issues related to online promotions. Through the use of pooled drawings, an interactive promotion builder wizard and unique distribution channels through banner advertisements on existing high traffic web pages (e.g., search engines and small business portals), advertisers of all sizes can customize, implement and administer sophisticated online promotions that attract customers (and customer data) for future marketing efforts. These banner advertisements may be delivered through an advertisement serving network (as is commonly known) where potential end user consumers exist, and may not be delivered by the promotion builder site itself.

The following sections detail the structure and function of each of the three core concepts of the present invention that, when integrated with each other, provide a wide variety of advantages over traditional systems and methods. The final section provides a detailed example of an advertiser using the pooled drawing and interactive wizard to design and administer one exemplary online promotion. Although many features and sub-combinations are provided, nothing in this description is intended to limit the present invention to any particular application of the invention or any particular grouping of features.

Core Concept 1: The Promotion Builder Wizard

Currently in the marketplace, especially for small businesses, promotions are built manually on a one-off basis. Typically, an agency designs a concept and then manually constructs the campaign. The present invention, in its preferred embodiments, facilitates a more streamlined and flexible approach to the initial design of the promotion by inviting the user (e.g., an advertiser) to participate in an online, wizard-driven technology to build its own custom promotion in a matter of minutes, without the need for specialized computer or other technological expertise.

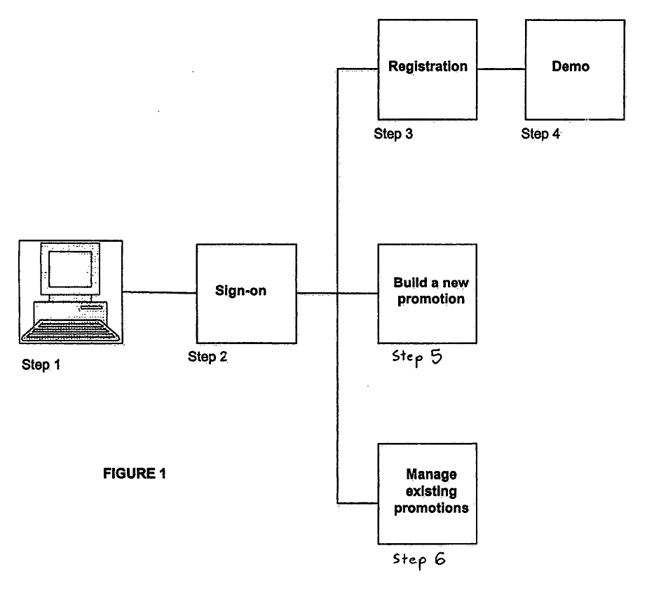

FIGS. 1-3 are detailed flow charts that describe the promotion building process according to a preferred embodiment of the present invention. Specifically, FIG. 1 is a flow chart showing a high level overview of the advertiser process for creating an online promotion.

The advertiser accesses the promotion builder website utilizing a personal computer (or other suitable device) with a web browser and an Internet connection (Step 1).

Preferably, the builder website includes explanatory information relevant to the various types of promotions that may be built with the system, the various types of ways in which the promotions may be built, and the rules/regulations/laws applicable to participating in the builder website and promotion creation system.

Once the advertiser decides to utilize the system, the advertiser logs onto the system as either a new user (first time utilizing the system) or an established user. In typical fashion, the system authenticates the advertiser by way of a username/password combination as part of a login or sign-on process (Step 2). The system may at this or another time prompt the advertiser for additional registration information about the user, the user's company or organization (e.g., contact information), and/or the methods by which the advertiser intends to pay for the use of the system (e.g., billing information) (Step 3). In various embodiments, the registration process may occur at the end of the promotion building session so that advertisers are encouraged to utilize the system and experience all of its features without having to formally register with the system. The system preferably includes a video demo or other media presentation that informs the user about the system, the promotion building process and other information that may be of use to the advertiser (Step 4).

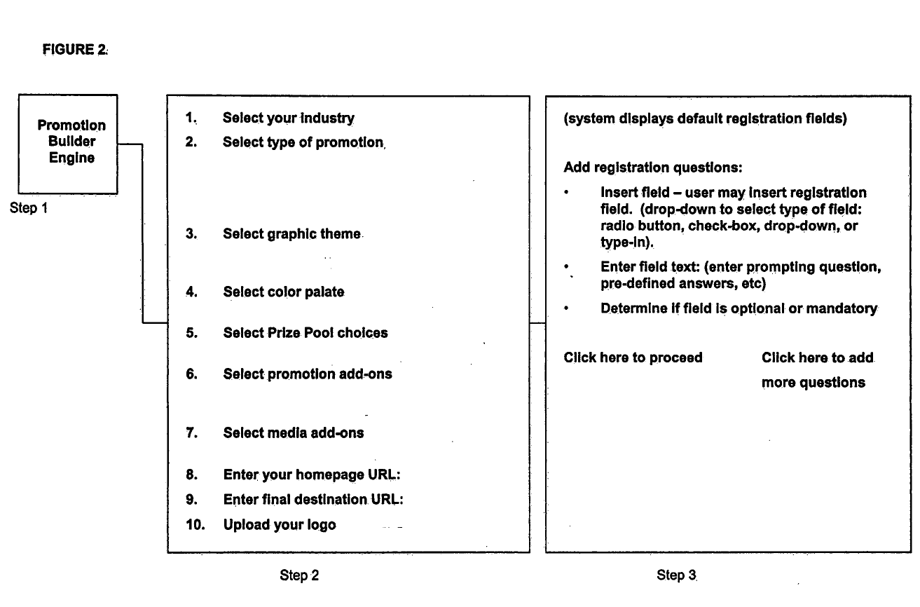

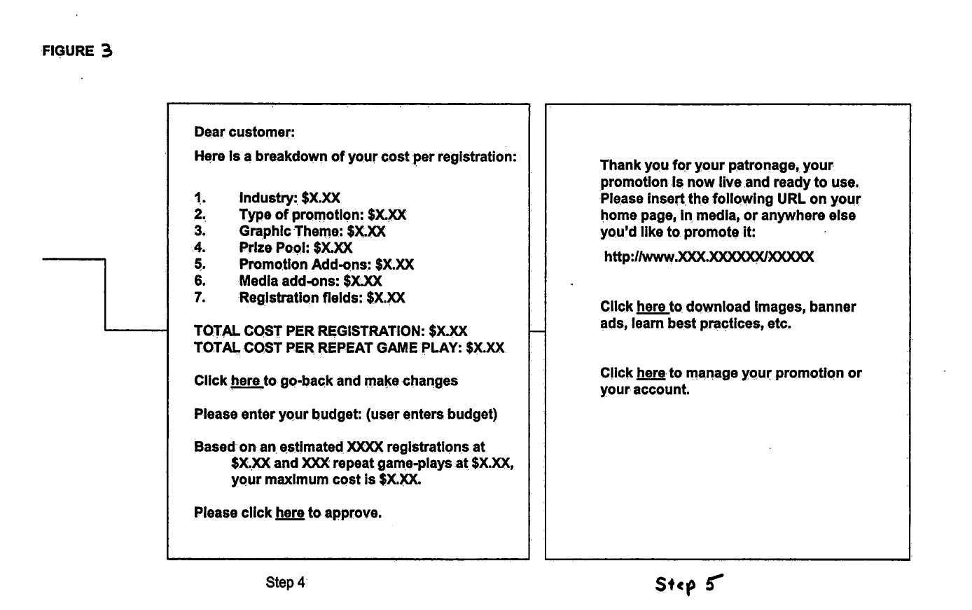

After the registration process, the advertiser is in a position to begin building a promotion using the wizard-driven interface (Step 5). The process for building a promotion utilizes an automated builder software engine that includes a web-based wizard front end in order to streamline the process for the advertiser. The wizard guides even an inexperienced user through a wide variety of customized selections that enable the advertiser to build and customize a promotion that bests suits its marketing needs. The actual use of the web-based wizard is described in more detail below with respect to FIGS. 2 and 3.

After building a promotion, the system of the present invention allows the advertiser to manage the administration of its promotion electronically (Step 6).

For example, the promotion management functionality preferably provides advertiser access to administrative, reporting (i.e., data mining) and management tools in order to oversee its promotion and the current results of users (consumer's) of the promotion.

FIG. 2 details exemplary steps in the beginning stages of an advertiser's use of the promotion builder. In FIG. 2, the web-based wizard begins when an advertiser decides to build a new promotion (Step 1 of FIG. 2 corresponding to Step 5 of FIG. 1). The wizard-driven interface prompts the user with a series of queries to gather information in order to produce a relevant promotion. In this way, the system automatically translates information about the advertiser's business goals and preferences into a relevant online promotion. Preferably, the system guides the user through this process by using a series of pull-down/drop-down menus or other common web-based devices to input information.

Step 2 of FIG. 2 details certain key information that may be queried of the advertiser in building a promotion. For example, the system may use a drop-down menu to prompt the advertiser to select from a pre-defined list of industries. Next, the system may prompt the advertiser to select from a list of available types of promotions. In this example, the promotion may be selected from the following group: sweepstakes; instant-win; trivia; collect-n-win; rebate; buy/get; points-based reward; coupon; special offer; and/or mystery offer/coupon. Alternatively or additionally, other well-known types of promotions may be offered as part of the promotion builder wizard including: refunds; contests (general); games (general; and sampling premiums; all of which may be associated with special packs, events and/or special experiences. All of these types of promotions are well known to those skilled in the promotion arts. Depending on the type of promotion that is selected, additional relevant inquiries may be made to the advertiser as would be well known to those skilled in the art of online promotions.

After selecting the industry and type of promotion, the system may query the advertiser to select from a predefined list of aesthetic or ornamental features to be used for the online promotion (Step 2). For example, a general graphic theme may be selected from a list of standard professional quality themes and a color palette may be selected from a predefined group or designed by the advertiser according to the colors commonly utilized by that advertiser in marketing materials. Many different aesthetic aspects of the promotion may be designed and/or selected as would be well known to those skilled in the art.

The next part of the promotion builder wizard preferably prompts the advertiser to select one or more prize pool choice(s). The prize pools may include one or more specific prizes that are awarded at various time intervals (e.g., daily, weekly, monthly). Preferably, the prize pools are separated into different themed categories (Home & Garden, Automotive, etc.), and within each themed category there may be a variety of different prize pools available. By selecting one or more prize pools or individual prizes, the advertiser's promotion will be associated with that prize and the end users (i.e., consumers) that register for that particular. promotion have a chance to participate in or win that particular prize pool. In some embodiments, there may be a separate prize pool wizard that guides the advertiser to a specific prize pool through a series of relevant questions about the advertiser's industry and marketing goals, as well as the size, type and frequency of prizes within each prize pool.

The promotion builder also allows the advertiser to select various “add-ons” that can be utilized as part of the promotion process (Step 2). For example, promotion add-ons may include: tell-a-friend; advanced reporting; VIP auto-reminders; opt-in reach-back and others. While these concepts are well known in the general promotion arts, this specific application of these and other add-on features have not here-to-fore been incorporated within a promotion wizard approach to promotion creation.

Additionally, media add-ons may include: featured promotion; higher placement and other services that allow the advertiser's promotion to receive preferential treatment over other similar promotions or to receive preferential treatment over other advertisers participating in the same promotion. A media add-on generally consists of a specialized section of “property” in any collaborative environment to attract end user attention. For example, in the case of a search engine, a “property” would be created on the search results page such as a “featured promotion” section of the page. This area of the search results screen is sold at a premium to advertisers to be used in conjunction with search key words. Such a unique and highlighted area of the screen generates better click-through rates and registration. Similar media add-on concepts are available for other collaborative environments.

To finalize the creation of the online promotion via the wizard-driven promotion builder, the advertiser is assigned a homepage Universal Resource locator (URL) and a final destination URL, and the advertiser is able to upload a logo or other graphical information that may be used as part of the web-based promotion. Preferably, the system develops, manages and assigns the site URL.

After setting up the content and aesthetic aspects of the promotion (Step 2 of FIG. 2), the web-based promotion builder continues to prompt the advertiser to design a registration form for users of the promotion (Step 3 in FIG. 2). In this portion of the promotion builder, the system presents the advertiser with default registration fields that are commonly presented to users of the promotion after the promotion is built. To add or change the registration form, the system guides the advertiser through the insertion and setup of each portion of the registration form. For example, the advertiser can add a field to the registration form by selecting “insert field” and then selecting which type of field will be included on the registration form (e.g., radio button, drop-down menu, or free text fill-in box). For each of these text fields, the system then guides the advertiser through the process of adding text associated with each of the selected types of fields. The system then guides the advertiser through the insertion of a prompting question to be included in the registration as well as the pre-defined answers to each of the questions (if the question has only pre-defined answers). The advertiser may also select whether the field is mandatory or optional, with the mandatory fields being required before a user is able to sign up or enter the promotion.

Through this registration-form builder, the advertiser is able to fully customize its own promotion registration form without the need for the advertiser to have extensive knowledge about HTML coding or other computer-based expertise. In this way, the advertiser can collect customer information that is relevant to its own industry or business that may not otherwise be relevant to other industries. Such focused customer information is greatly preferred in targeted advertising.

After the advertiser has used the promotion wizard to build its promotion and registration screens, the user can preview the promotion (as built) and experience the promotion from an end user's perspective. In this way, before the promotion is available to the public, the advertiser can detect any problems that an end user may encounter and can utilize the promotion builder to edit and alter the promotion to address these problems. This preview and editing function streamlines the process and reduces the chance that errors will be communicated to the end users that register for or enter the promotion.

FIG. 3 is a continuation of the promotion builder process shown in FIG. 2. After previewing and accepting the promotion, the system preferably provides the advertiser with a summary of costs related to the promotion as built (Step 4 in FIG. 3). As noted in Step 4, the costs associated with the promotion are determined based on the various selections made by the advertiser during the promotion building process. As shown in the FIG. 3 example, the cost per registration is affected by the industry, type of promotion, graphic theme, prize pool, promotion add-ons, media add-ons, and registration fields that are selected by the advertiser. These particular selections and costs per registration are exemplary only and suitable alterations and extensions are well known to those skilled in the art. The system automatically calculates and displays to the advertiser the total cost per registration (CPR) and the total cost per repeat game play (CPP) for the promotion that has been built. Based on the pricing, the advertiser can go back and make changes to its promotion if desired.

At this point, the system queries the advertiser to pre-approve a budget (an amount that is authorized to be spent based on customer activity) for the promotion. The system calculates an estimated amount of registrations and/or repeat game-plays based on the budgeted amount and the calculated CPR/CPP. Once the advertiser is content with both the substance of the promotion as well as the number of potential registrations based on the budget, the system processes the advertiser's credit card to ensure validity and to place the budgeted amount as an approved preauthorization on the credit card. At this point in time, the advertiser accepts the promotion and budget, and the system returns an order confirmation form to the advertiser (Step 5 in FIG. 3).

As customers register for the promotion and/or repeatedly play the promotion games, the advertiser's credit card will be charged the appropriate amount, perhaps as part of a monthly billing cycle. As part of the accounting of the system, the system preferably notifies the advertiser when user registrations have used up 70%, 80% and/or 90% of the budget. Within these emails, the advertisers are given a simple process in which the advertiser can extend the pre-approved budgeted amount for the promotion on its credit card. If, at any point in time, the budgeted amount is used in full (between CPR and CPP), the system removes access to the promotion from that advertiser's creative presentation or website.

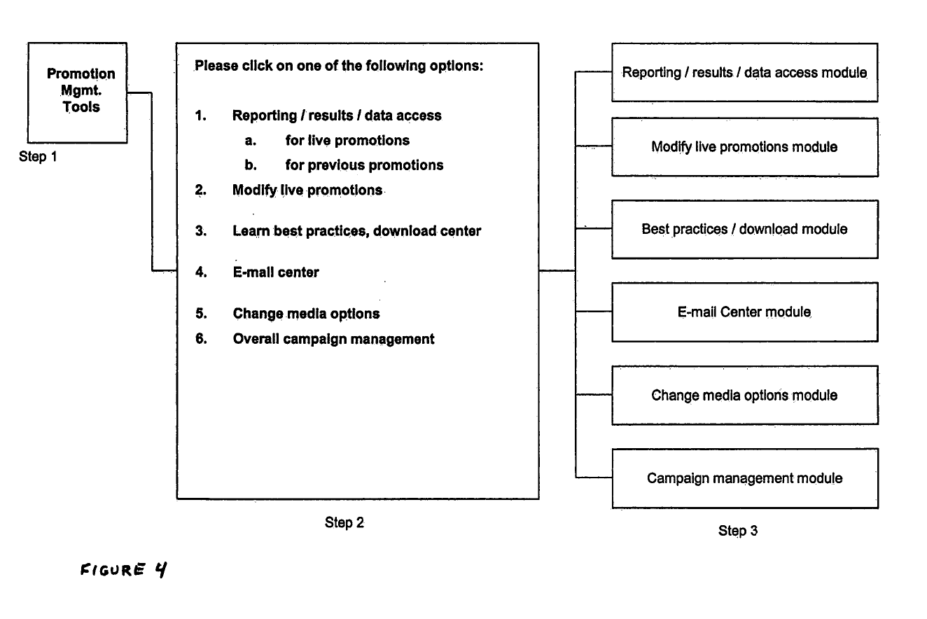

FIG. 4 details some of the promotion management tools that can be utilized by the advertiser to manage various aspects of their promotion and information about the end users. For example, by accessing the online promotion management tools module (Step 1 in FIG. 4), the system preferably presents the advertiser with a variety of different options that the advertiser may utilize to manage its promotion (Step 2 in FIG. 4). In the example provided, the advertiser may select from the following options: reporting/results/data access for both live (current) promotions and previous (archived) promotions; modify or edit a live promotion (e.g., colors, themes, text, logos); learn best practices, download center (e.g., images, banners); e-mail center (create schedule or send email to the advertiser's database); change media options; and/or overall campaign management. Selecting any of these high level choices opens additional appropriate web pages or windows in which an advertiser can perform the related task or receive the requested data. In the FIG. 4 example, the additional web pages or windows are designated “modules,” and a module is shown in the figure (Step 3) corresponding to each of the high level selections (Step 2) just described.

After the promotion is completed, the system creates the promotion and provides a URL that links consumers (i.e., users of the promotion) to the promotion. The technical aspects of the promotion itself are hosted on the sponsors' web servers, but the advertiser can post the link to the promotion on its own website, in online advertisements or in any other manner that the advertiser desires in order to direct end users to the promotion. The system itself (or the sponsor of the promotion) may also host websites or supply advertisements that draw users to the promotion.

Core Concept Two: Themed Prize Pools

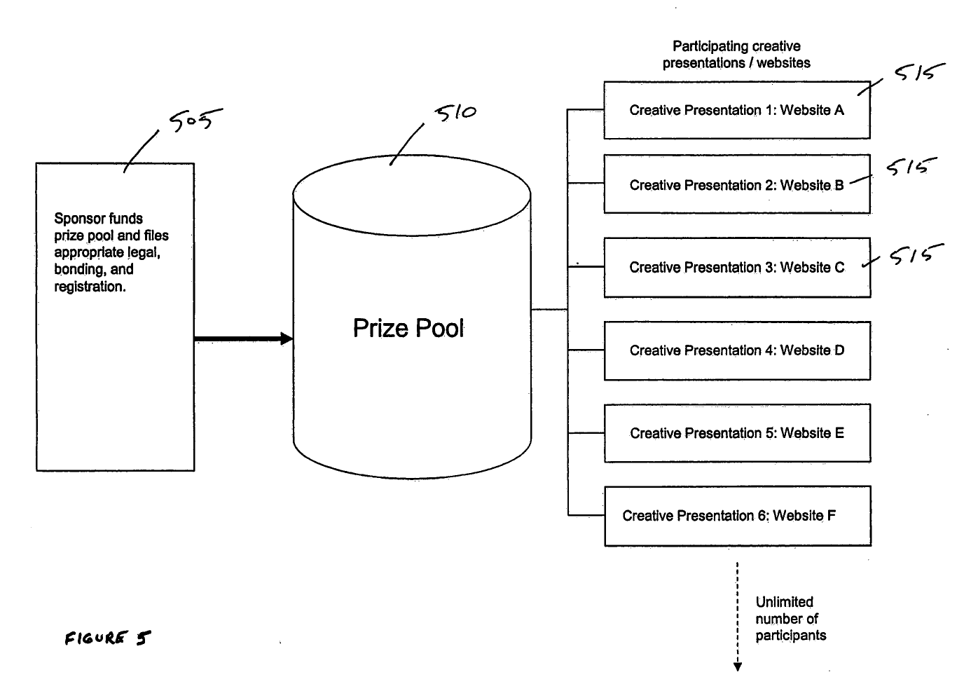

A second integrated feature of the present invention is the “pooled drawing” element as generally set forth in FIG. 5. This aspect of the present invention leverages a single prize pool promotion across a virtually unlimited number of “creative presentations.” This shared-prize program allows advertisers to deploy a promotional campaign without the typical costs of prizing, or the typical time commitment and hassles associated with promotions (e.g., registration, bonding, legal fees, prize fulfillments, 1099s, sweepstakes administration, etc.).

As an example, an instant-win prize pool may include 1 personal computer, 25 radios and 100 personal digital music players. This single promotion, sponsored by a single business entity, is prepared in accordance with standard sweepstakes law. Official Rules and Regulations are prepared by lawyers associated with the sponsoring entity, and the promotion is registered in those jurisdictions in which registration is necessary in order to participate. The sponsor, who is preferably an expert in the administration of all types of promotions, procures the necessary surety bonds and ensures that the promotion is legal in every jurisdiction in which users may participate (e.g., all 50 U.S. states). In this way, the sponsor, who preferably owns and administers the promotion building website, takes care of all promotion-related tasks and the advertiser is relieved of these burdens.

The sponsor may then syndicate participation by offering companies to serve as entry points into this promotion. For example, both Company A and Company B may offer instant-win promotions on their websites. When consumers view the Official Rules, they are clearly notified that they are participating in a pooled drawing, and that the prize pool is being offered by the sponsor and is being made available through many different entry points. The Official Rules clearly state that the winner may or may not come from the site (entry point) from which the user has entered and that multiple such sites are participating. In the present example, instant-win technology randomly awards exactly the number of prizes offered in the pool across the total universe of participating sites.

Since prize pool promotions are established in advance, an advertiser can participate and launch his or her own entry point within a matter of minutes with the use of the wizard-driven promotion builder discussed above. This is in strong contrast to the traditional promotion building process which typically takes weeks and costs thousands of dollars between legal fees, registration fees, bonding, prizes, fulfillment, tax processing and similar promotion-related expenses. The present invention's “ready-to-go” promotions are unique and save the advertiser time and money—especially smaller advertisers that could not otherwise pay to build and participate in a promotion.

FIG. 5 is a flow chart of an exemplary pooled drawing approach according to the present invention. The flow chart of FIG. 5 shows that a single sponsor (505) can perform all of the funding and administrative work associated with the prize pool (510) while a virtually unlimited number of participating creative presentations/websites (515) can be access points to the prize pool. All technical, legal, financial and other impediments to setting up a large scale prize pool are absorbed by the sponsor (510) through the implementation of the present invention.

Specifically, the prize pool (510) in the center of FIG. 5 represents the one or more prizes that are to be given away across a wide variety or promotion entry points (515). The sponsor (505) provides the funding and administrative/legal/technical knowledge to create and run the prize pool (510). The right-hand boxes represent various different advertiser entry points (515) to the prize pool (510) which may take the form of different creative presentations and/or different websites. The example in FIG. 5 shows a single sponsored prize pool (510) being accessed by at least 6 different advertisers (515) (creative presentations 1-6 and websites A-F).

Core Concept Three: The Distribution Channels

As a third core concept of the system, use of the present invention also includes a distribution and billing model that specifically facilitates the goals of the invention. The distribution and billing models of this concept preferably include the following methodology:

Step 1: An advertiser decides to build a promotion via the automated promotion builder engine (FIGS. 2 and 3).

Step 2: The advertiser is able to launch the program instantly while ensuring that the promotion is legal in all 50 states (or other relevant jurisdiction) due to the pooled drawing feature.

Step 3: The advertiser launches the program for free, but commits in advance to pay a cost-per-registration (CPR) or cost-per-play (CPP) fee to the sponsor.

The aspect of the cost-per-registration/cost-per-play billing model pertaining to a promotion has not traditionally been implemented. Further, the distribution methodology will be via partners (e.g., web search engines or small business web portals) in addition to through a more traditional direct selling model.

The present invention may also include various other features including the concept of a featured promotion section on a paid search results page, as well as tying billing fees (CPR/CPP) to better positioning in paid search marketing. These are two examples of add-ons that advertisers can utilize (at a premium) if certain promotions warrant the use of these features.

It is also noted that the variable-based pricing model for additional features has not traditionally been implemented. The costs are preferably calculated based on the promotion type, features, add-ons, number/type of registration fields, prizing, and/or other promotional aspects. In addition, the price may be impacted based on a supply and demand/auction model in which advertisers may bid for more advanced promotions in a competitive auction-style format.

The Special Offer Builder Wizard

The present invention may also include a special offer builder tool that allows advertisers to create consumer incentives in a variety of different forms. For example, consumer incentives may take the form of: special offers; coupons; gift certificates; rebates and other specific transaction-based calls to action. The special offer builder tool preferably includes a wizard driven interface (similar to the promotion wizard) that is adapted to guide an advertiser through the process of designing and deploying one or more special offers, separate and apart from any promotion created above. In fact, these special offers can be created without being tied to a promotion or prize pool in any way.

The special offer builder wizard-driven interface guides an advertiser through a variety of key features about the special offer. For example, the advertiser may be prompted to select: a price point (e.g., $1.00 off, $3.00 off, etc.); a percent discount (e.g., 20% off, 30% off, etc.); multiple purchase (e.g., buy one get one free); and a product description. The special offer wizard may also prompt the advertiser to limit the special offer in some way, such as by adding constraints (e.g., limit one per visit, limit one per customer) or managing the expiration date (fixed: Dec. 12, 2010 or variable: 10 days from viewing). The special offer wizard may also guide an advertiser through a variety of pre-formatted legal options and security features. Finally, the advertiser can easily customize the special offer by selecting from a variety of predefined themes and forms as well as by uploading logos, business information and URLs that can identify the source of the special offer.

The system is unique in that these services are pre-built and designed as logical selections within a wizard environment. This aspect of the present invention allows the advertiser to manage the development of the offer as well as gain valuable consumer registration data in the process of presenting the offer. Traditional solutions focus on mechanics such as secure printing, print and user limits, etc. The present invention focuses instead on creation and deployment.

The Promotion Wizard In Use

A detailed example of the use of the pooled drawings and web-based wizard-driven promotion builder will now be provided. As explained in the previous sections, the first aspect of the present invention comprises an online promotion builder that is driven by a web-based wizard. Herein, an exemplary promotion based generally on an instant-win game will be presented. Although many different aspects of the present invention are detailed within this example, it is not intended to limit the present invention to the presently disclosed examples or selections.

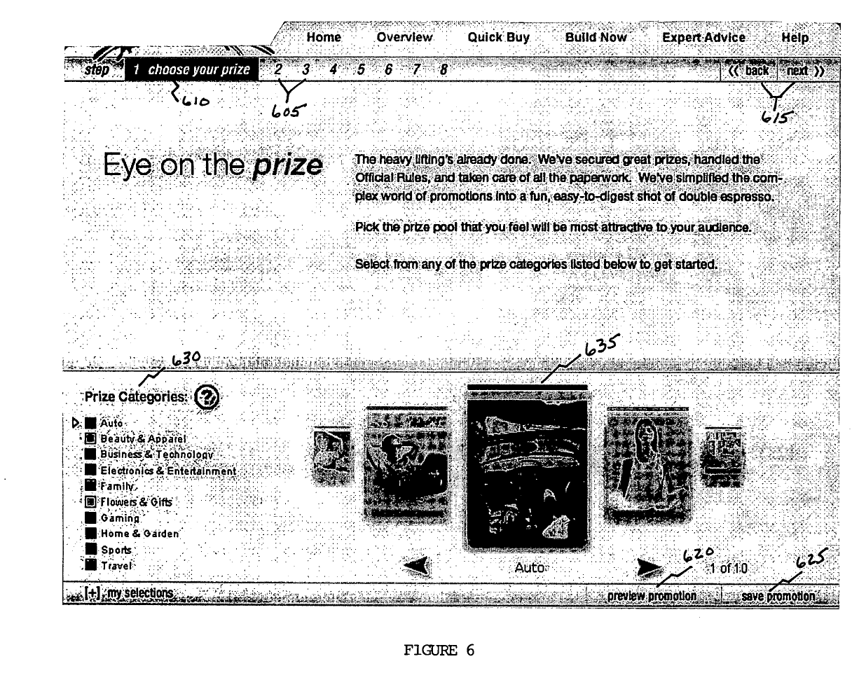

After making the decision to create an online promotion, the advertiser uses a web browser to access the web-based, wizard-driven promotion builder software. A screen shot of an early page in the promotion building process is shown in FIG. 6. In the present example, the promotion builder process is segmented into eight distinct process steps (605) as shown in FIG. 6. The current step (610) (of the eight steps) is highlighted and the advertiser can move forward or backward through each step using the “back” and “next buttons” (615) at the top of the promotion builder screen. Also, at all times after the selection of the initial elements of the promotion, the advertiser can select the “preview promotion” button (620) to view the promotion as currently created by the advertiser and the “save promotion” button (625) in order to save the promotion so that it may be further edited and/or finalized in a later session.

In this example, the first step (610) in the process is to select a pre-existing prize pool to join. As shown in FIG. 6, the prize pools may be segregated into different categories of prizes (630) (e.g., Auto, Beauty & Apparel, Business & Technology, etc.) and a picture (635) of a prize or a picture that represents a themed category of prizes is preferably displayed to guide the advertiser. Selecting (e.g., with a mouse) the picture of one of the prize pool categories brings up a menu of all currently available prize pools in that category.

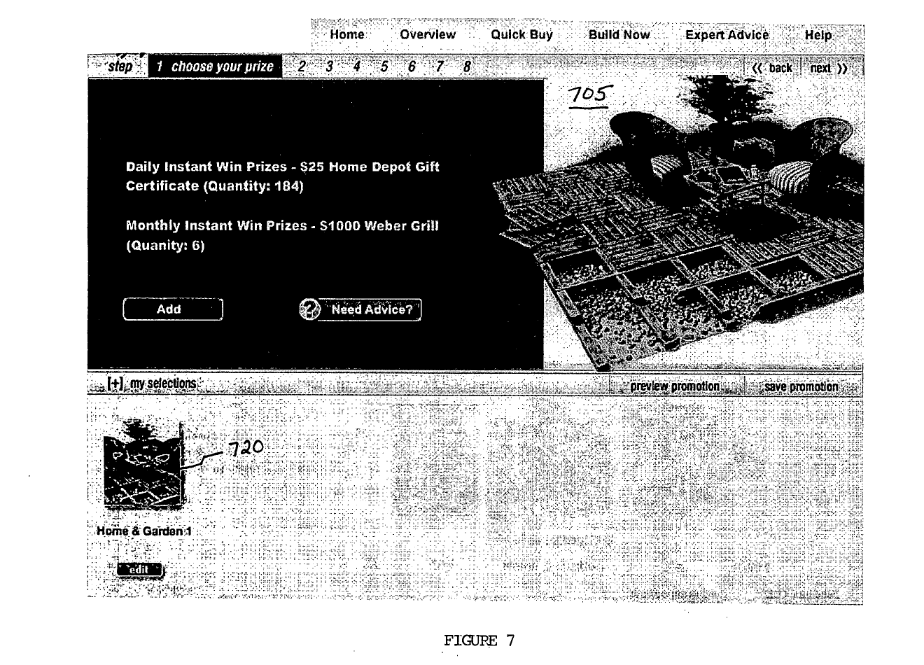

FIG. 7 depicts a screen shot of a page of the promotion builder wizard in which the advertiser has selected “Home & Garden” prize. In the upper portion (705) of FIG. 7, two prize pools are depicted: (1) a daily instant win game (710); and (2) a monthly instant win prize (715). These may be individual prizes or they may be grouped together as a single prize pool that the advertiser may join. Additional details about the prize and additional expert help (e.g., through a virtual expert) may be linked to the page. Once selected (e.g., by selecting “add”), the chosen prize pool is made part of the advertiser's promotion and is represented in the lower portion of the page as “my selections” (720). As with all parts of the web-based promotion wizard, these selections (720) are only temporary at this stage, and the promotion may be previewed, edited and altered in a variety of different ways until the advertiser is satisfied.

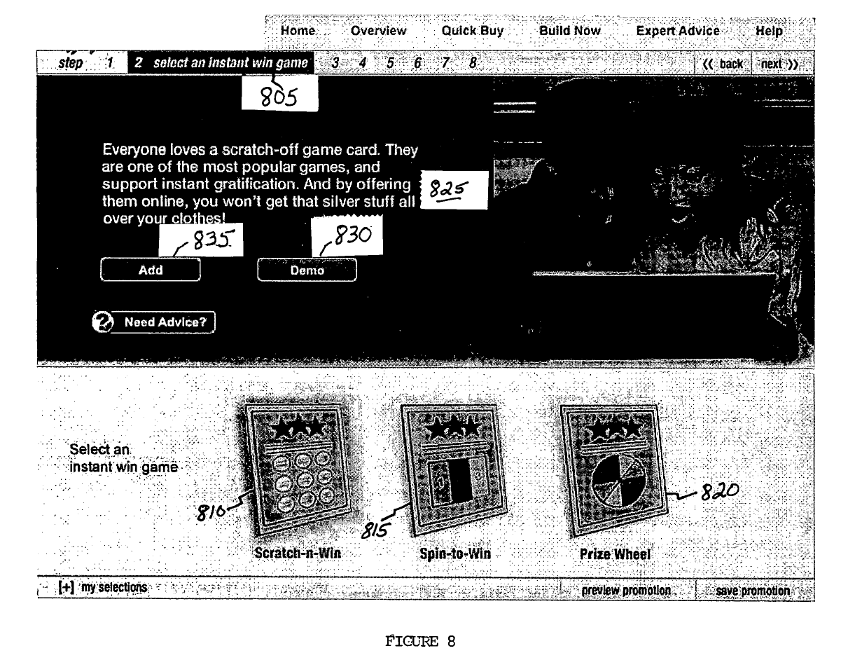

After selecting “next” (615) the advertiser moves to the second step of the promotion builder process (see FIG. 8). In this example, the second step (805) is the selection of the type of instant win game to be included in the program. Here, this selection is based upon the selection (in Step 1 above) of a prize pool tied to an instant win prize, but the selection of a particular game is not limited thereto. In FIG. 8, there are three different types of instant win games that may be selected: (1) a Scratch-n-Win game card (810) (similar to a lottery ticket); (2) a Spin-to-Win game (815) (similar to a slot machine); and (3) a prize wheel (820).

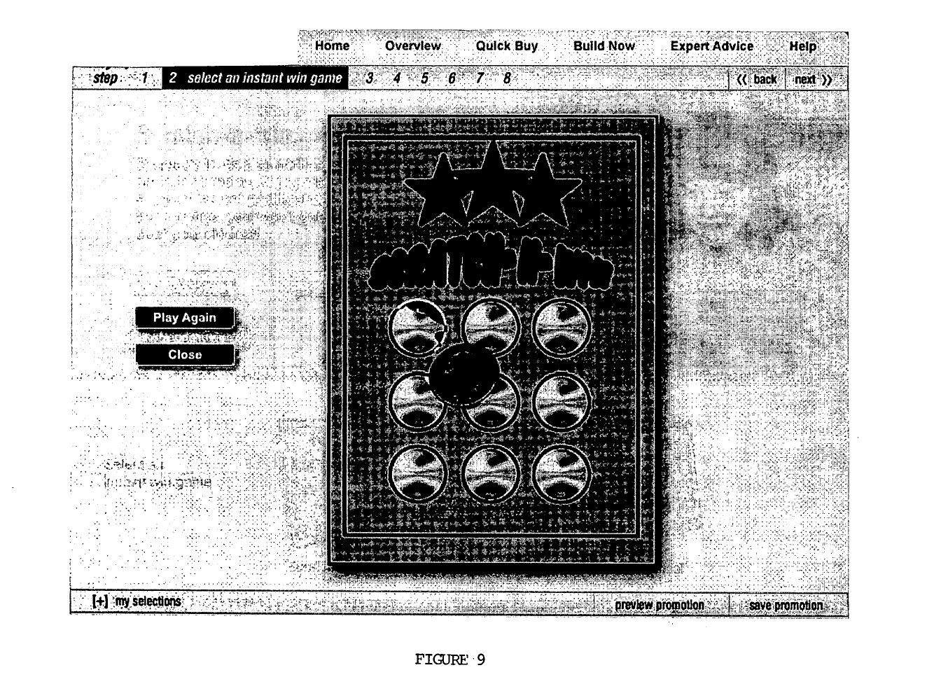

By selecting any of these types of instant win games (810, 815, 820) in the lower portion of FIG. 8, details and selections related to the selected game are displayed for the advertiser in the upper portion (825) of the screen. For example, the additional information may include virtual expert advice, a demo of the game (830), and/or the ability to add (835) the game to the advertiser's promotion. FIG. 9 shows a demo of a Scratch-n-Win game as an example.

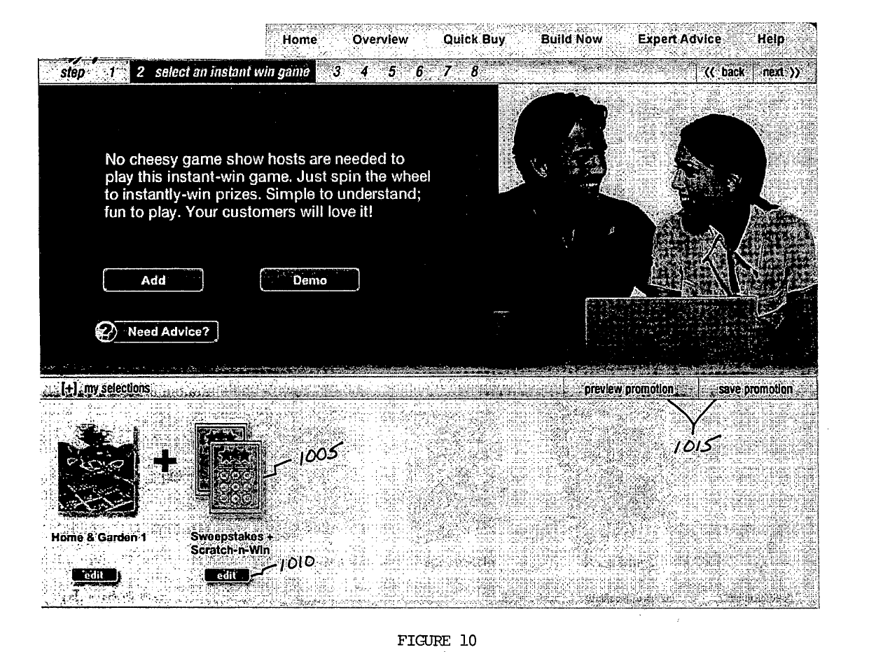

After selecting to “add” (835) the Scratch-n-Win to the current promotion, it will be added to the list of “my selections” (1005) in the lower portion of the promotion builder screens (see FIG. 10). Note that each selection is shown next to each other to easily see all selections at the same time and that each selection includes an individual “edit” button (1010) so that the particular selection can be easily altered. Note too that as the promotion is built with increasing complexity, the “preview” and “save” buttons (1015) are still accessible to enable the advertiser to see the promotion as currently designed and save the partially built promotion to be continued at a later time.

The rest of the web-based promotion builder wizard process proceeds in a similar fashion, at all times guiding the advertiser through the proper selection of appropriate elements without the need for extensive knowledge of promotions, computer programming or even design. In the present example, the third step in the process is the selection of a theme and color scheme for the online promotion. The predefined themes preferably include aesthetically pleasing design elements that convey a unified message to the end user. For example, if the prize pool is related to home improvement, the theme may be based around a garden or tools. If the prize pool included a vacation, the theme of the promotion may be pictures of a beach or the prize destination. An almost limitless variety of themes (which include background images, foreground images, fonts, sounds, animations, etc.) and colors may be presented to the user so that a professional-looking promotion can be developed with little effort but with a high degree of flexibility.

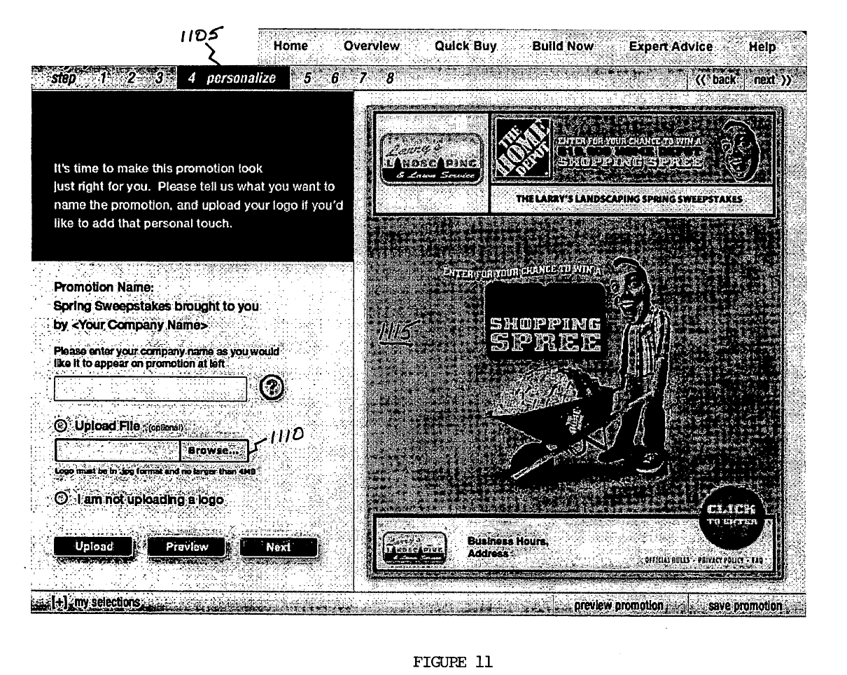

In the present example, the fourth step (1105) of the promotion building process provides for an even greater degree of personalization of the promotion. As shown in FIG. 11, the advertiser may enter company name, address and hours of service information. The advertiser can upload (1110) a company logo or other picture to be displayed as part of the entry screen to the promotion. Preferably, as the user enters information into the web-based forms on the left hand side of the promotion builder screen, the preview (1115) of the promotion in the right hand of the screen will be updated in real time. In this way, the advertiser can see the effect of each entry and each decision on the promotion itself. This real time preview functionality interjects a high degree of efficiency in the promotion process.

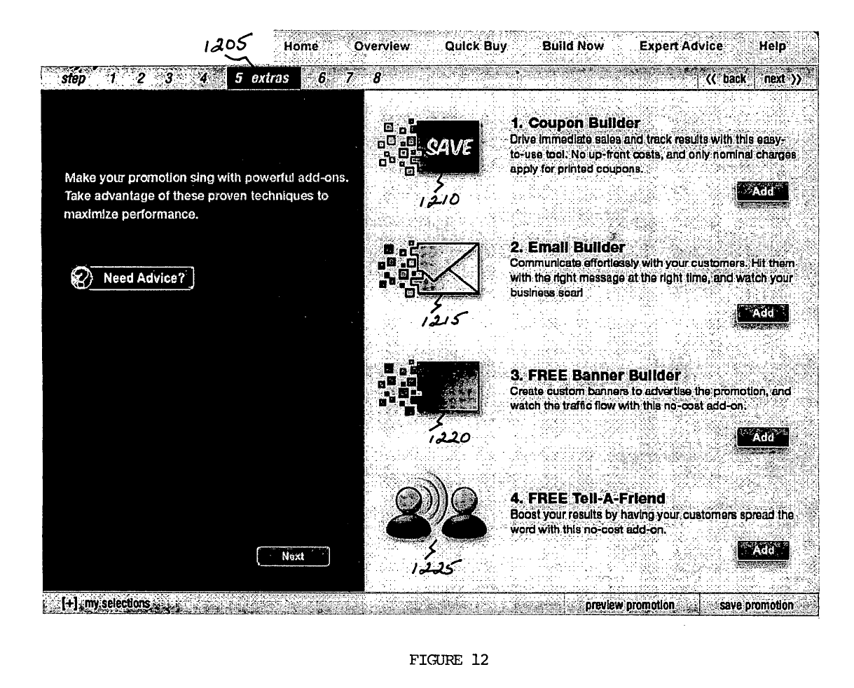

As the fifth step (1205) in the exemplary wizard-driven promotion builder process, the advertiser is able to select “extras” that may be added to its online promotion (see FIG. 12). These extras may include a wide variety of promotion add-ons as described generally above. In the FIG. 12 example, there are four types of add-ons that are presented: (1) a coupon builder (1210); (2) an email builder (1215); (3) a banner builder (1220); and (4) a tell-a-friend option (1225). Generally speaking, the coupon builder (1210) allows an advertiser to put an electronic coupon (to be printed by the end user) on the promotion page, the email and banner builders (1215, 1220) allow the advertiser to design a targeted customer email and various web banner advertisements, respectively, and the tell-a-friend option (1225) allows end user customers to refer other people to the promotion.

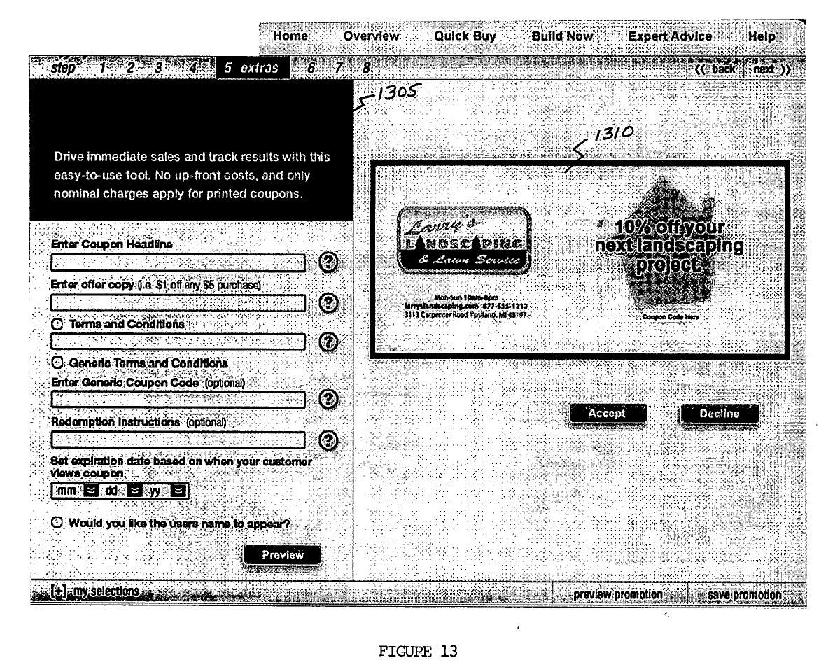

FIG. 13 shows an exemplary screen from the promotion builder wizard used by an advertiser to design an online coupon. As with the “personalize” option (1105) described above (1210), the advertiser is able to design the coupon via an interactive form on the left hand side (1305) of the screen while simultaneously viewing the coupon (1310) being built in the right hand side of the form. In this example, the advertiser can define a coupon title and copy, terms and conditions, redemption instructions and an expiration date. There could also be the ability to upload unique images to be used as part of the electronic coupon or a variety of other customizable features.

The email builder (1215) is similar to the coupon builder in that the advertiser uses an interactive web-based form to enter information about the contents, recipients and timing for sending emails that directly offer special offers to a selection of end users. The advertiser can also customize a “results” screen (part of the advertiser's administrative functions described above) in order to collect the most appropriate information related to the sending and receiving of these direct marketing emails. The system is capable of tracking a variety of different email-related information such as total number of emails sent/delivered/opened, the number of users that clicked on any web links within the email and/or the number of users that opted-out of receiving additional emails.

All of this information is useful in designing future online and offline promotions.

The banner advertisement builder (1220) preferably includes an interactive method to create various web-based banner advertisements that can be used across the top, bottom, sides or within the body of advertiser-based or third party websites to direct traffic to the advertiser's promotion. Preferably, the system uses the information and images collected during the creation of the promotion in order to automatically design and build various types and sizes of banner advertisements. The user may then resize, reformat or otherwise edit the banner advertisements.

The tell-a-friend option (1225) provides a simplified way for customers that have joined the promotion to direct their friends and family members to the promotion. In utilizing this option, the advertiser customizes a form that the customer fills out when making the referral (i.e., tells a friend about the promotion), and the advertiser is also able to customize the email that is sent in response to a customer filling out the form. For example, the form itself may include the promotion title and logo, and the form may query the end user for the referral's name and email address. When an end user enters this information and selects “send,” an email which explains the promotion, provides hyperlinks to the promotion and identifies the customer that is making the referral is sent from the system to the referral. Since the email is ostensibly coming from a friend, it is likely to be met with a much higher positive response rate than a direct marketing email without any context.

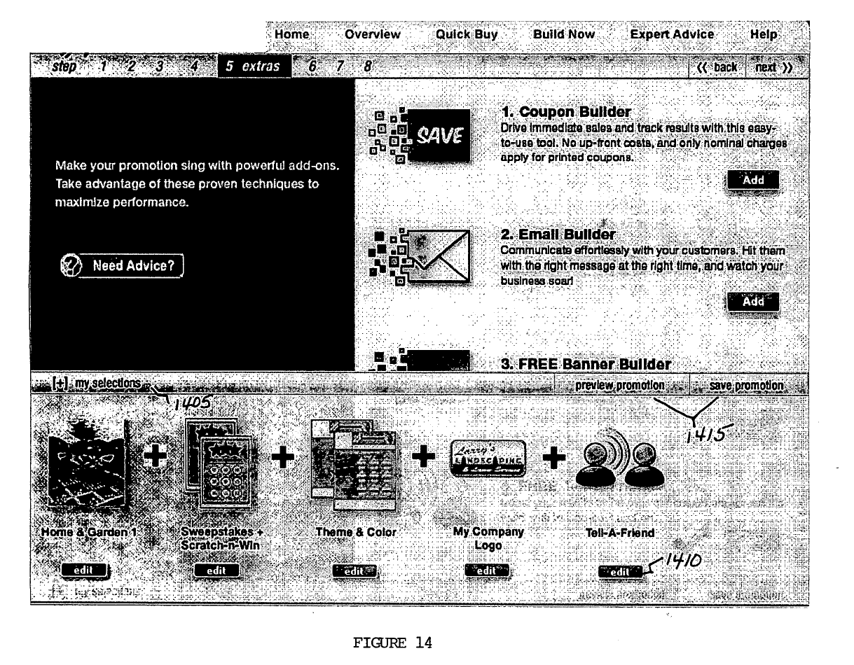

FIG. 14 shows an updated page after the advertiser has selected the tell-a-friend option as part of the “extras.” Note that the “my selections” portion (1405) of the promotion builder screen details all of the choices made by the advertiser throughout the entire process of building its customized promotion. Just as before, each of the selected features has an “edit” button (1410) to further refine that part of the promotion, and the advertiser can continue to preview and save (1415) the promotion if required.

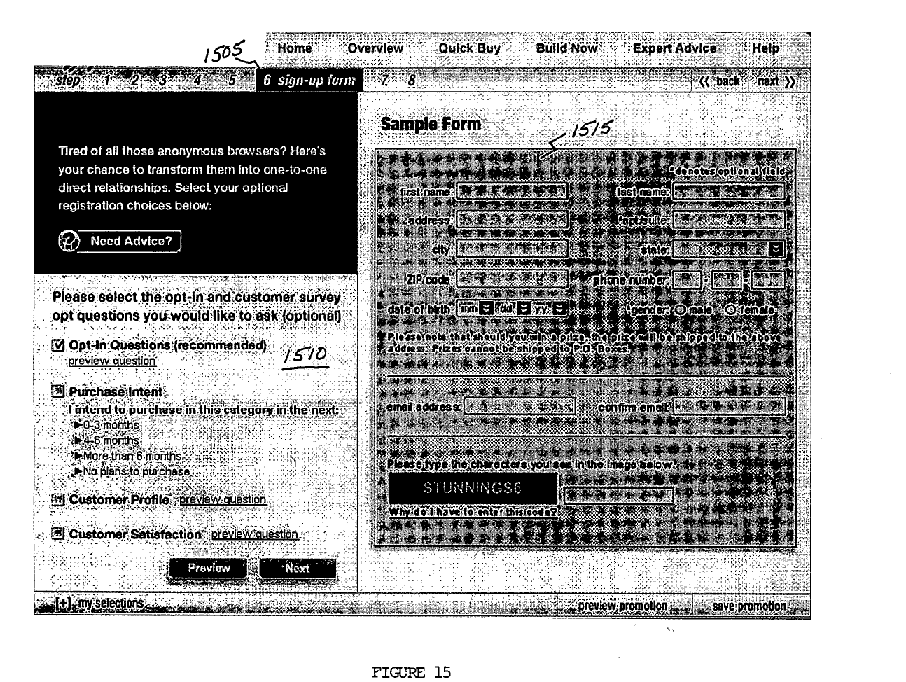

The sixth step (1505) in the exemplary process allows the advertiser to design the end user's registration process in order to maximize the amount of information that the advertiser can obtain about each end user. FIG. 15 shows a screen shot of the promotion builder form used by an advertiser to design the end user sign-up form. Again, selections related to the content of the form (1510) (left hand side of the form) are shown at the same time as a preview of the form itself (1515) is shown (right hand side). Here the selection form (1510) includes the ability for an advertiser to customize opt-in questions, purchase intent questions, customer profiles information, and questions related to customer satisfaction. Typical or recommended questions may be provided as examples from which the advertiser can select the most appropriate selections, or the advertiser may prepare a new question or required registration information that is even more suited to its particular industry. The scope and variety of the design of the end user registration form is virtually limitless.

The seventh step in the online promotion builder wizard of the present example relates to setting a budget for the use of the promotion. Since the system preferably does not charge an advertiser any upfront cost to develop and rollout the promotion, the advertiser is able to set a forward-looking budget for the promotion to which the system can automatically adhere. In this way, an advertiser can keep close track of all of the financial information related to the promotion and make informed decisions about the continuation of the present promotion or about subsequent promotions based thereon.

More specifically, once the promotion is built up through the registration screens, the system analyzes each of the selections made by the advertiser in the promotion builder process and automatically calculates a “cost per unique registration” and “cost per repeat game play” for that promotion. Some of the promotion builder options may be free of charge (e.g., tell-a-friend and banner ad builder) and some of the other selected features may be assessed a cost per instance. For example, the electronic coupons that were designed as part of the present promotion may be assessed at $0.05 per coupon, and the direct marketing emails may be assessed at $0.005 per email message sent. The more options (or the more involved those options are), the higher the price. However, the advertiser is aware of all aspects of the price before he submits final approval of the promotion.

Based on the amount of money the advertiser is going to be charged for the promotion, as automatically calculated by the system, the advertiser is then queried to enter a weekly budget, an overall budget cap for the promotion and limits for users to repeatedly play each instant win (or other) game. Based on the entered budget, the system can automatically estimate how many users can sign up, play the games repeatedly and/or use the couponing and other features of the promotion. Moreover, based on typical practices, the system can also automatically calculate typical results for end users, such as the number of registered customer sign-ups per week, the number of referrals, and the number of coupons printed.

As described above, since the system pre-approves a user credit card only for the amount indicated in the advertiser's budget, the advertiser is better able to control its expenditures. As the use of the promotion by customers nears the limit of the budget (e.g., 70%, 80%, 90%), the system preferably emails the advertiser to prompt the advertiser to extend the budget or the system will be forced to automatically close down that advertiser's entryway into the promotion.

The final step in the process presents the advertiser with an online form to provide additional information about the advertiser's company, the advertiser's industry and the method of payment (i.e., a credit card or other preauthorized/pre-funded form of payment). Again, the user can preview the final version of the promotion and review the system's rules and terms of service before accepting the promotion. After acceptance, the promotion is live on the system, and the advertiser can begin to drive traffic to the promotion. The system provides the URL of the promotion, provides the banner ads to be used by the advertiser on other websites and otherwise makes the promotion available until it expires or is taken down for some other reason.

At this point, the system also makes available all of the advertiser “management” functions that can be used to track, report and manage the promotion. This management module is the entry point for the advertiser to perform a variety of different administrative and record-keeping tasks as described in more detail above.

At this point, the customized promotion has been completed, the advertiser has joined a prize pool and customers are free to join the promotion.

Nothing in the above description is meant to limit the present invention to any specific materials, geometry, or orientation of elements. Many part/orientation substitutions are contemplated within the scope of the present invention and will be apparent to those skilled in the art. The embodiments described herein were presented by way of example only and should not be used to limit the scope of the invention.

Although the invention has been described in terms of particular embodiments in an application, one of ordinary skill in the art, in light of the teachings herein, can generate additional embodiments and modifications without departing from the spirit of, or exceeding the scope of, the claimed invention. Accordingly, it is understood that the drawings and the descriptions herein are proffered only to facilitate comprehension of the invention and should not be construed to limit the scope thereof.

What is claimed is:

1. A method for creating and administering a pooled promotion, comprising the steps of:
electronically providing an automated wizard-driven promotion builder to an advertiser;
electronically receiving advertiser-provided information that defines a prize pool associated with the promotion, the type of game associated with the promotion and additional aesthetic aspects of the promotion;
receiving budget information from the advertiser;
calculating and monitoring a per-entry cost of utilizing the promotion; and
automatically monitoring the cost associated with the use of promotion against the advertiser-provided budget.

2. The method of claim 1, further comprising the step of:
automatically creating banner advertisements linked to the promotion based upon the advertiser-provided information.

3. The method of claim 1, further comprising the step of:
automatically distributing banner advertisements linked to the promotion through search engines based upon the advertiser-provided information.

4. The method of claim 1, wherein the type of web-based promotion is selected from the group consisting of sweepstakes, instant-win, trivia, collect-n-win, rebate, buy/get, points-based reward, coupon, special offer, and mystery offer/coupon.

5. The method of claim 1, wherein the type of web-based promotion is selected from the group consisting of refunds; contests; games; and sampling premiums.

6. The method of claim 1, where in the type of web-based promotion is an instant win game and said promotion further comprises:
an electronic coupon.

7. The method of claim 1, wherein the content selections for the web-based promotion include a promotion add-on selected from the group consisting of tell-a-friend, advanced reporting, VIP auto-reminders and opt-in reach-out.

8. The method of claim 1, wherein the content selections from the web-based promotion include a media add-on selected from the group consisting of featured promotion and higher placement of the promotion in a ranked resulted page.

9. The method of claim 1, further comprising the step of:
providing an electronic advertiser access to reporting content related to said promotion.

10. The method of claim 1, further comprising the step of:
distributing said promotion over the Internet as part of a search engine results page.

11. The method of claim 10, wherein said promotion includes a media add-on that creates a “featured promotions” area on said search engine results page.

12. The method of claim 1, wherein said additional aesthetic aspects of the promotion include a predefined group of color and content themes for said promotion.

13. The method of claim 1, wherein said additional aesthetic aspects of the promotion include logos uploaded by said advertiser and advertiser-defined color schemes.

14. The method of claim 1, wherein said promotion includes an advertiser-defined user registration page including advertiser-defined opt-in questions and customer profile information.

15. The method of claim 1, wherein said automated wizard-driven promotion builder includes a preview button so that an advertiser can preview a partially designed promotion as design selections are being made by the advertiser.

16. The method of claim 1, wherein said automated wizard-driven promotion builder includes a video-based expert advice.

17. A system for creating and administering a pooled promotion, comprising:
means for electronically providing an automated wizard-driven promotion builder to an advertiser;
means for electronically receiving advertiser-provided information that defines a prize pool associated with the promotion, the type of game associated with the promotion and additional aesthetic aspects of the promotion;
means for receiving budget information from the advertiser;
means for calculating and monitoring a per-entry cost of utilizing the promotion; and
means for automatically monitoring the cost associated with the use of promotion against the advertiser-provided budget.

18. The system of claim 17, wherein the prize pool is selected from a group of predefined prize pools that are organized into subject headings.

19. A system for creating and administering a pooled promotion, comprising:
an automated wizard-driven promotion builder that is electronically presented to an advertiser, said wizard adapted to receive advertiser-provided information that defines a prize pool associated with the promotion, the type of game associated with the promotion, additional aesthetic aspects of the promotion and budget information from the advertiser;
means for calculating and monitoring a per-entry cost of utilizing the promotion; and
means for automatically monitoring the cost associated with the use of promotion against the advertiser-provided budget.

20. A method for creating and administering a special offer promotion, comprising the steps of:
electronically providing an automated wizard-driven special offer builder to an advertiser;
electronically receiving advertiser-provided information that defines a price point, product description and legal options associated with the special offer;
receiving budget information from the advertiser;
calculating and monitoring a per-use cost of utilizing the special offer; and
automatically monitoring the cost associated with the use of special offer against the advertiser-provided budget.
